(19) United States
(12) Patent Application Publication
(10) Pub. No.: US 2013/0007646 A1
(43) Pub. Date: Jan. 3, 2013

(54) USER INTERFACE FOR BUILDING A SEARCH QUERY

(76) Inventor: Scott Robert Tranter, Washington, DC (US)

(21) Appl. No.: 13/513,881

(22) PCT Filed: Dec. 13, 2010
(86) PCT No.: PCT/US2010/060030

§ 371 Date: Jun. 5, 2012

Related U.S. Application Data
(60) Provisional application No. 61/286,946, filed on Dec. 16, 2009.

(51) Int. Cl. G06F 3/048

(52) U.S. Cl. 715/769

(57) ABSTRACT

This description herein relates to a computer, a user interface, and a method for providing a user interface for a computer, wherein the user interface is for building a search query. The user interface allows a user to build a search query with visual manipulations of cells. Accordingly, complex search query may be easily and quickly built and at the same time reduce the errors commonly associated with text string search queries.

### FIELD

This description relates generally to a computer having a user interface, a user interface for building a search query, a method of building a search query on a computer, and a computer having a user interface for building a search query.

### BACKGROUND

A user interface having a click, scroll, and selecting a preset variable and data for the selected variable for building a search query is known. Such an interface has a limited and predetermined set of variables and predetermined set of data for each variable. Another user interface having a type entry format for building a search query is also known. A search query is a process request for retrieval of particular information from a database. The scope of the process request is based on the terms and the logical connectives between the terms used in the search query.

An example of a user interface is a computer having a text entry box window interface displayed on a display device, wherein a user uses a keyboard to enter various terms to build a search query. A combination thereof wherein a first cell has a preset number of variables wherein a particular variable may be chosen by a click, scroll, and select method and then a second cell has a text entry box wherein a term may be entered to build a search query is also known.

A user interface having a type entry format for building a search query may allow a plurality of terms to be entered into the text entry box. For example, with terms “cat” and “dog” may be entered into the text entry box. This kind of a user interface for building a search query is very primitive because it is not clear how the terms in the text box are logically connected. Generally, in such primitive user interfaces, the two terms “cat” and “dog” are connected logically by a logical connective OR even though the OR function is not implicitly entered. Thus, a formal representation or notation of such a query would be equivalent to:

Cat OR Dog Accordingly, this kind of user interface does not allow a user to build a more complex or focused search query.

There are user interfaces wherein a logical connective may be entered with terms to build a search query. Examples of commonly used logical connectives are AND, OR, NAND, NOR, XAND, XOR, and NOT. These logical connectives are commonly known as Boolean Operators and are used with a computer having a keyboard. These logical connectives are entered by alphanumeric characters. Accordingly, the logical connectives represented by alphanumeric characters are limited by the use of the hardware associated with the device. An example of search terms connected with logical connectives may be described as follows. In a text entry box, the terms “Cat,” “Dog,” “Fish,” and “Bird” may be logically connected as:

(Cat AND Dog) OR (Fish AND Bird)

Below is a more complex search query example, more search terms are logically connected using logical connectives.

((Cat AND Dog) OR (Fish AND Bird)) NAND ((Cat AND Fish) OR (Dog AND Bird))

Further, there are generally many different ways of typing a text string search query that requests the same result. For example, a faceted Boolean query, which is an example of a logical connective, is a plurality of parenthetical OR linked statements linked together by AND operator. The following faceted Boolean query:

(Cat OR Dog) AND (Fish OR Bird)

is a query that requests the same search that matches the following query:

(Cat AND Fish) OR (Cat AND Bird) OR (Dog AND Fish) OR (Dog AND Bird)

Accordingly, the resulting output of the above two faceted Boolean queries would be the same when the queries are requested from the same database.

To perform a more complex or focused search, a more sophisticated search query must be built. In a more sophisticated search query, special alphanumeric characters may be used to represent certain logical connectives or other meanings dictated by the limitations of the computer's input device. For example, on a computer having a keyboard, a user must learn and/or memorize certain special alphanumeric characters, or combinations thereof, that represent logical connectives. For example, the special alphanumeric character “!=” can be equivalent to a NOT logical connective. For example, the special alphanumeric character “*” may be a wildcard character. Further, certain variables may be identified to request a focused search. For example, the variable of “date” may be specified and within that variable, certain terms, such as “July” may be searched for in a query. Other variables, such as “animal” and “name” used below as an example, may also be used to build a more focused search query. Below is an example of a complex search query using terms and alphanumeric symbols that represent some Logical connectives along with specified variables and search terms:

{[(date = “June” or “July” or “August”) and (date != “January” or
“March”)] or [(date = “April” or “May”) and (date != “June”)]} and
[(animal = “Cat” or “Dog”) and (animal != “Fish”)] and [(name = *spot*
or *kitty*) and (name != *tiger*)]

As it is exemplified above, as searches become more focused and/or particular, the query can become more complicated to build using a text string. Further, the need to use multiple parenthetical groupings in the text string can make the search query difficult to create and/or difficult to understand. Further, any error in the typed text string would cause an input error, or an operation error, resulting in a null result. Even an error in the parenthetical nesting can cause such an error. Perhaps even worse, it is possible that the returned result may not be what the user intended. Generally, a focused search requires longer and more complicated text string. As the search text string gets longer and more complicated, chance of making an error is increased. Building a complex search text string can be difficult, time consuming, and/or frustrating to fix if there is an error.

All of the above stated limitations are further acerbated on a on a computer that does not have a keyboard connected to it. For example, a computer that does not have a keyboard is a gaming device having a gamepad. For example, a computer that does not have a keyboard is a portable computer having a touch sensitive screen interface. On these example computer devices, even the commonly used alphanumeric logical connectives would be difficult to type into the user interface. For the gaming device or the computer having a touch sensitive screen interface, an alphanumeric keypad would likely have to be displayed on the screen for a user to use or interact with the displayed alphanumeric keypad to enter the logical connectives with search terms. One disadvantage of such an interface would be that the displayed alphanumeric keypad takes up a portion of the display screen, thus blocking the main screen image from the user's view. Another disadvantage of such an interface may be the significantly slower speed and accuracy as compared to a standard keyboard. These inherent deficiencies of the user interface exist because these user interfaces are designed around the keyboard using alphanumeric keys, whether they be a physical device or screen display.

Further, there are many other logical connectives that are represented by notations which are not easily represented by alphanumeric characters. Accordingly, such Logical connectives are not easy to use on a computer having a keyboard. For example, material implication Logical connective has the notation ⊃. As another example, material nonimplication Logical connective has the notation ⊃. For both of these logical connectives, equivalent alphanumeric character representations are difficult to accomplish.

Accordingly, devices and methods having an improved user interface for a computer are desirable.

### BRIEF SUMMARY

This description relates to a computer, a user interface, and a method for providing a user interface for a computer, wherein the user interface is for building a search query.

In an embodiment, the computer having a user interface displayed on a display device is provided. The user interface includes a plurality of cells that are interactable. An example of a cell that is interactable is a cell that may be manipulated via drag and drop. Each cell includes or has an unselected state, and a selected state. The user interface includes a first query area, including at least one cell, a second query area, including a first query tab, a first query window associated with the first query tab, wherein the first query window is displayed when the first query tab is selected. The first query window is configured to display the cells that are dragged and dropped into the first query window, and wherein the cells displayed in the first query window are linked together by a first logic operator. The cell that is dragged and dropped is configured to be selectable, wherein when the cell is selected, a visual indicator of the cell indicates the selected state of the cell. The user interface also includes a data cell, a commit button, wherein the data cell is configured to accept entering a data, and display the data entered, wherein when the commit button is activated, the data is logically linked to the cell that is in the selected state, and a linked cell is displayed in a query display area, wherein the linked cell visually represents the cell that is in the selected state and logically linked to the data.

The computer may also include the user interface including the second query area that includes a second query tab, and a second query window associated with the second query tab. The second query window is displayed when the second query tab is selected. The second query window is configured to display the cells that are dragged and dropped into the second query window, and the cells displayed in the second query window are linked together by a second logic operator. Further, the cell that is dragged and dropped is configured to be selectable, wherein when the cell is selected, the visual indicator of the cell indicates the selected state of the cell. The embodiment includes a second data cell, a second commit button, wherein the second data cell is configured to accept entering a second data, and display the second data entered, wherein when the second commit button is activated, for example by clicking, the second data is logically linked to the cell that is in the selected state displayed in the second query window, and a second linked cell representing the cell in the selected state displayed in the second query window that is logically linked to the second data is displayed in the query display area. Further, the first query window is a first parenthetical expression of the cells displayed in the first query window, the second query window is a second parenthetical expression of the cells displayed in the second query window, and the first parenthetical expression is linked by a third logic operator to the second parenthetical expression.

In another embodiment, a computer is provided comprising a display device and a user interface displayed on the display device. The user interface includes a query area, including a plurality of cells. Each cell is configured to be interacted via drag and drop. A cell display area is displayed on the display device that displays the cells. The user interface includes a query building area, including a first query tab, and a second query tab. A first query window is associated with the first query tab, wherein the first query window is displayed when the first query tab is selected, wherein the first query window is configured to display the cells that are dragged and dropped into the first query window, and wherein the cells displayed in the first query window are linked together by a first logic operator. The user interface includes a second query window associated with the second query tab, wherein the second query window is displayed when the second query tab is selected, wherein the second query window is configured to display the cells that are dragged and dropped into the second query window, and wherein the cells displayed in the second query window are linked together by a second logic operator. The first query window is a first parenthetical expression of the cells displayed in the first query window, the second query window is a second parenthetical expression of the cells displayed in the second query window; and the first parenthetical expression of the cells displayed in the first query window is linked by a third logic operator to the second parenthetical expression of the cells displayed in the second query window.

The computer may also include the user interface that includes cells displayed in the first and the second query windows that are configured to be selectable, wherein the cell that has been selected is visually represented as a selected cell. The user interface may also include a query display area, and a cell display area that displays a data cell and a confirmation cell. The data cell is configured to accept entering a data and display the data entered. The confirmation cell is configured to be clickable. When the confirmation cell is clicked, the selected cell is logically linked to the data entered in the data cell, and a linked cell is displayed in the query display area. The linked cell represents the selected cell that is logically linked to the data. The query display area configured to logically link the linked cell.

In another embodiment, the computer further includes the user interface further including a second query area configured to display one or more linked cells. The query display area is a third parenthetical expression of the linked cells displayed in the first query display area. The second query display area is a fourth parenthetical expression of the linked cells displayed in the second query display area. The third parenthetical expression is linked by a fourth logic operator to the fourth parenthetical expression.

In another embodiment, the computer further includes the user interface wherein the data cell includes a first text box and a second text box, wherein the first text box is configured to accept and display a lowest range limit of data, wherein the second text box is configured to accept and display a highest range limit of data, and wherein when the selected cell is logically linked to the data entered in the data cell, the selected cell is logically linked to a range of data defined by the lowest range limit of data and the highest range limit of data.

Another embodiment is a user interface displayed on a display device of a computer. The user interface may be displayed on the display device via a software, program, script, or any other method of producing a display on a display device according to a predetermined set of instructions. For example, a webpage is a user interface. For example, client program associated with a server is a user interface. For example, a stand-alone program may also be a user interface. For example, an application for a mobile device may be a user interface.

The user interface includes a plurality of cells that are interactable. An example of a cell that is interactable is a cell that may be manipulated via drag and drop. Each cell includes or has an unselected state, and a selected state. The user interface includes a first query area, including at least one cell, a second query area, including a first query tab, a first query window associated with the first query tab, wherein the first query window is displayed when the first query tab is selected. The first query window is configured to display the cells that are dragged and dropped into the first query window, and wherein the cells displayed in the first query window are linked together by a first logic operator. The cell that is dragged and dropped is configured to be selectable, wherein when the cell is selected, a visual indicator of the cell indicates the selected state of the cell. The user interface also includes a data cell, a commit button, wherein the data cell is configured to accept entering a data, and display the data entered, wherein when the commit button is activated, the data is logically linked to the cell that is in the selected state, and a linked cell is displayed in a query display area, wherein the linked cell visually represents the cell that is in the selected state and logically linked to the data.

The user interface may also include the second query area that includes a second query tab, and a second query window associated with the second query tab. The second query window is displayed when the second query tab is selected. The second query window is configured to display the cells that are dragged and dropped into the second query window, and the cells displayed in the second query window are linked together by a second logic operator. Further, the cell that is dragged and dropped is configured to be selectable, wherein when the cell is selected, the visual indicator of the cell indicates the selected state of the cell. The embodiment includes a second data cell, a second commit button, wherein the second data cell is configured to accept entering a second data, and display the second data entered, wherein when the second commit button is activated, for example by clicking, the second data is logically linked to the cell that is in the selected state displayed in the second query window, and a second linked cell representing the cell in the selected state displayed in the second query window that is logically linked to the second data is displayed in the query display area. Further, the first query window is a first parenthetical expression of the cells displayed in the first query window, the second query window is a second parenthetical expression of the cells displayed in the second query window, and the first parenthetical expression is linked by a third logic operator to the second parenthetical expression.

In another embodiment, a user interface includes a query area, including a plurality of cells. Each cell is configured to be interacted via drag and drop. A cell display area is displayed on the display device that displays the cells. The user interface includes a query building area, including a first query tab, and a second query tab. A first query window is associated with the first query tab, wherein the first query window is displayed when the first query tab is selected, wherein the first query window is configured to display the cells that are dragged and dropped into the first query window, and wherein the cells displayed in the first query window are linked together by a first logic operator. The user interface includes a second query window associated with the second query tab, wherein the second query window is displayed when the second query tab is selected, wherein the second query window is configured to display the cells that are dragged and dropped into the second query window, and wherein the cells displayed in the second query window are linked together by a second logic operator. The first query window is a first parenthetical expression of the cells displayed in the first query window, the second query window is a second parenthetical expression of the cells displayed in the second query window; and the first parenthetical expression of the cells displayed in the first query window is linked by a third logic operator to the second parenthetical expression of the cells displayed in the second query window.

The user interface may include cells displayed in the first and the second query windows that are configured to be selectable, wherein the cell that has been selected is visually represented as a selected cell. The user interface may also include a query display area, and a cell display area that displays a data cell and a confirmation cell. The data cell is configured to accept entering a data and display the data entered. The confirmation cell is configured to be clickable. When the confirmation cell is clicked, the selected cell is logically linked to the data entered in the data cell, and a linked cell is displayed in the query display area. The linked cell represents the selected cell that is logically linked to the data. The query display area configured to logically link the linked cell.

In another embodiment, the user interface includes a second query area configured to display one or more linked cells. The query display area is a third parenthetical expression of the linked cells displayed in the first query display area. The second query display area is a fourth parenthetical expression of the linked cells displayed in the second query display area. The third parenthetical expression is linked by a fourth logic operator to the fourth parenthetical expression.

In another embodiment, the user interface includes herein the data cell includes a first text box and a second text box, wherein the first text box is configured to accept and display a lowest range limit of data, wherein the second text box is configured to accept and display a highest range limit of data, and wherein when the selected cell is logically linked to the data entered in the data cell, the selected cell is logically linked to a range of data defined by the lowest range limit of data and the highest range limit of data.

In another embodiment, a method is provided for providing a user interface for graphically building a search query. The method includes providing the user interface via a network to a remote display device from a server. The remote display device may be a part of a computer that is connected to the server via the network. The network may be the internet. The user interface may be a web page. The user interface may be a program that is downloaded to the remote computer and then when the program is executed, the user interface is displayed on the display device of said computer. The user interface may have the features already discussed above. In one embodiment, a method includes providing a user interface for graphically building a search query, via a network to a remote display device from a server, wherein the user interface displayed on a display device, includes a plurality of cells that are interactable via drag and drop. Each cell includes an unselected state, and a selected state. The user interface provided in the method includes a first query area, including at least one cell, a second query area, that includes a first query tab and a first query window associated with the first query tab, wherein the first query window is displayed when the first query tab is selected, wherein the first query window is configured to display the cells that are dragged and dropped into the first query window, and wherein the cells displayed in the first query window are linked together by a first logic operator. The method includes providing the user interface that includes wherein the cell that is dragged and dropped is configured to be selectable, wherein when the cell is selected, a visual indicator of the cell indicates the selected state of the cell. The user interface provided according to the method further includes a data cell and a commit button, wherein the data cell is configured to accept entering a data. The embodied method includes displaying the data when the data is entered, logically linking the data to the cell that is in the selected state when the commit button is activated, and displaying the data is logically linked to and a linked cell in a query display area, wherein the linked cell visually represents the cell that is in the selected state and logically linked to the data.

In another embodiment, the method further comprises providing the user interface that further includes the following. The second query area of the user interface that is provided according to the method, further includes a second query tab and a second query window associated with the second query tab, wherein the second query window is displayed when the second query tab is selected, wherein the second query window is configured to display the cells that are dragged and dropped into the second query window, and wherein the cells displayed in the second query window are linked together by a second logic operator. Further, the method provides that the cell that is dragged and dropped is configured to be selectable, wherein when the cell is selected, the visual indicator of the cell indicates the selected state of the cell. The user interface according to this embodiment includes a second data cell and a second commit button, wherein the second data cell is configured to accept entering the data, and display the data entered, wherein the second commit button is clickable. The embodied method includes displaying the data entered, logically linking the data to the cell that is in the selected state when the second commit button is clicked, and displaying a second linked cell representing the cell in the selected state that is logically linked to the data in the query display area. The embodied method further includes logically linking the cells displayed in the first query window as a first parenthetical expression, logically linking the cells displayed in the second query window as a second parenthetical expression, and logically linking the first parenthetical expression by a third logic operator to the second parenthetical expression.

### BRIEF DESCRIPTION OF THE DRAWINGS

FIGS. 1-9 are illustrations of various embodiments and/or not-to-scale examples.

FIG. 1 shows an embodiment of a computer including a display device, wherein a user interface is displayed on the display device.

FIG. 2 shows an embodiment of a user interface provided by a server via a network.

FIG. 3A shows an embodiment of a user interface.

FIG. 3B shows a display of the user interface of FIG. 3A.

FIG. 4A shows an embodiment of a user interface.

FIG. 4B shows a display of the user interface of FIG. 4A.

FIG. 5 shows an embodiment of a user interface.

FIG. 6 shows an embodiment of a user interface.

FIG. 7A shows an embodiment of a user interface.

FIG. 7B shows a display of the user interface of FIG. 7A.

FIG. 8 shows an embodiment of a user interface.

FIG. 9 shows an embodiment of a user interface.

FIG. 10 shows partial steps of an embodiment of a user interface.

FIG. 11 shows partial steps of an embodiment of a user interface.

FIG. 12 shows an embodiment of a step in the user interface shown in FIG. 11.

FIG. 13 shows an embodiment of a step in the user interface shown in FIG. 11.

FIG. 14 shows an embodiment of a step in the user interface shown in FIG. 11.

FIG. 15 shows an embodiment of a step in the user interface shown in FIG. 11,

FIG. 16 shows an embodiment of a query process.

FIG. 17 shows an embodiment of steps in creating an output.

### DETAILED DESCRIPTION

The term “cell” is used herein to include a computer icon, a pictogram, a text box, text, selected text, or a combination thereof, which is displayed or displayable on a display device of a computer.

The term “logically linked” is used herein to include associating two or more elements logically. The term “logically linked” is used herein to also include forming a logical connective. Logical connectives include binary logical connectives. Logical connectives include Boolean operators. Boolean operators are terms or symbols that represent Boolean logic. Examples of Boolean operators include AND, OR, and NOT. For example, Venn diagrams are one way of visually graphing logic sets made up of Boolean operators.

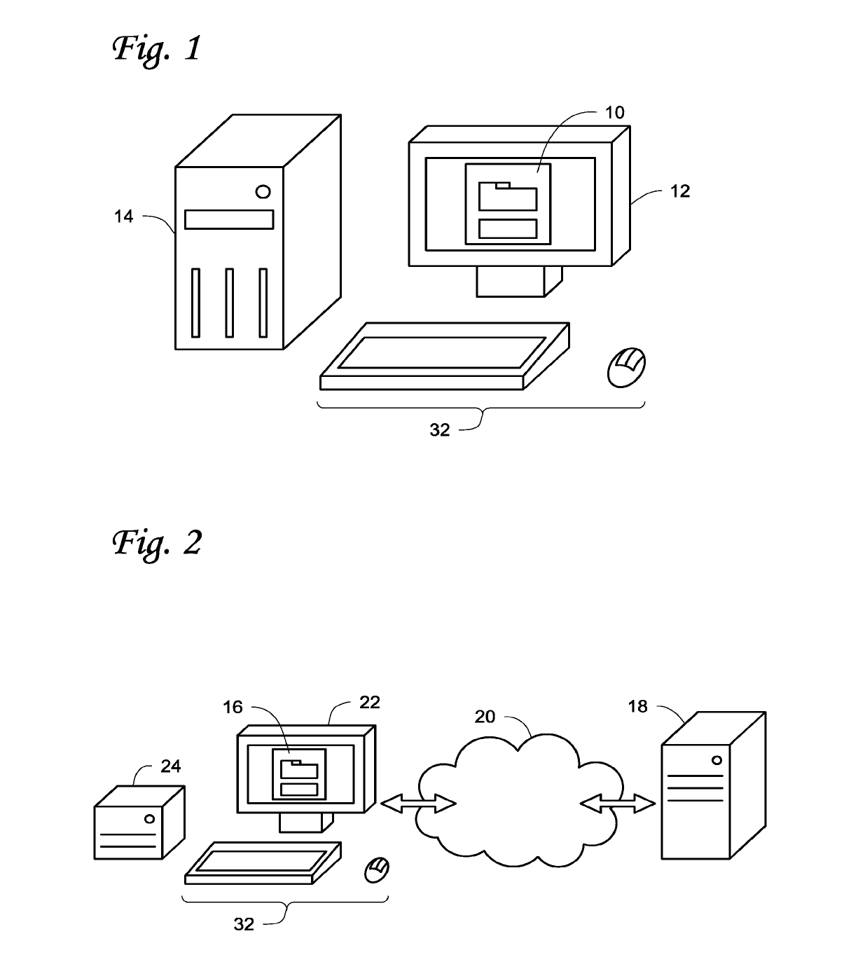

FIG. 1 shows a user interface 10. The user interface 10 is displayed on a display device 12 of a computer 14. The user interface 10 may be provided by software and hardware of the computer 14. The user interface 10 may be provided by another computer, such as a server, and displayed remotely on the display device.

FIG. 2 shows a user interface 16 provided by a server 18 via a network 20. The network 20 may be the Internet. Preferably, the user interface 16 is provided as a web page. The user interface 16 may be displayed on a display device 22. The display device 22 may be included in a computer 24.

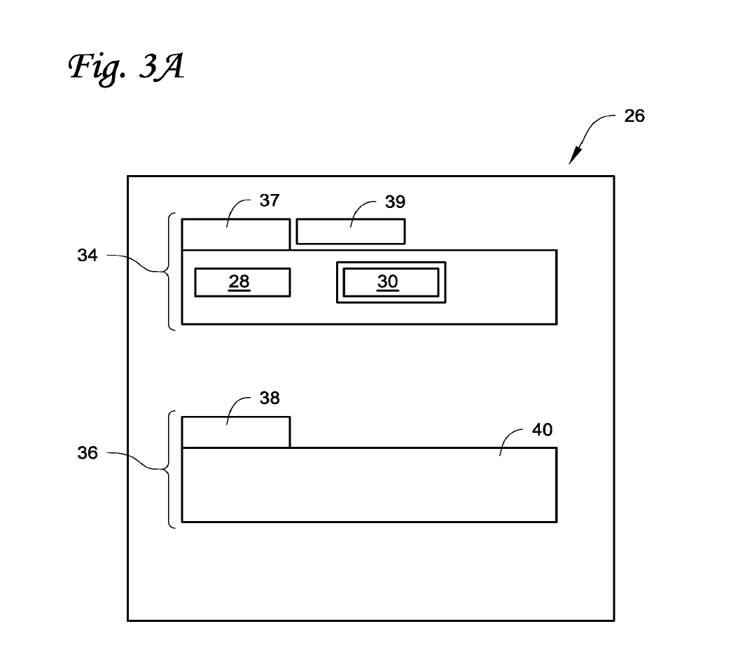

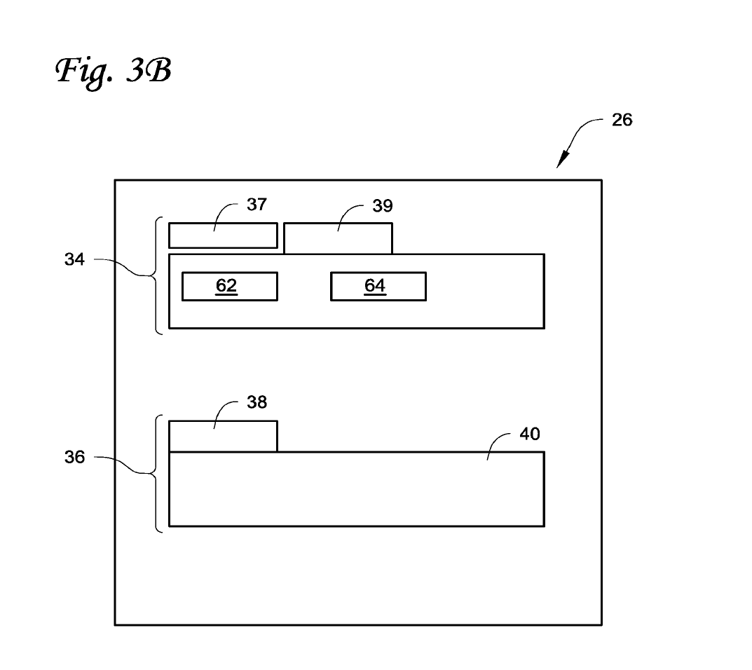

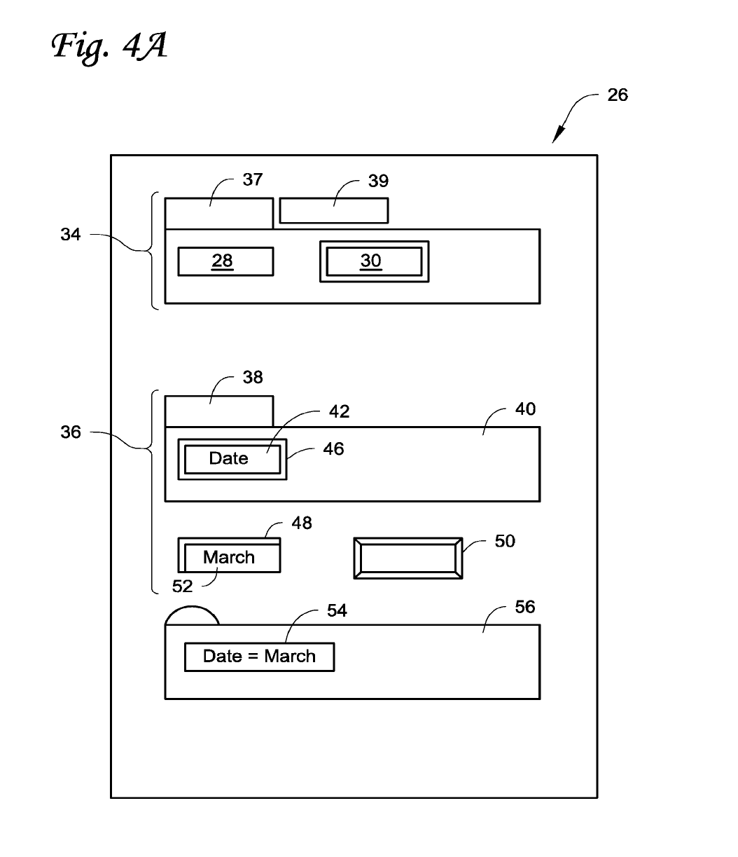

FIG. 3A shows a user interface 26 that includes a plurality of cells 28, 30.

The cells 28, 30 may be interactable, for example via drag and drop. The drag and drop interaction may be via a touch, by a cursor controlled by a human interface device 32, or a combination thereof. An example of a human interface device 32 is a gamepad. Another example of a human interface device 32 is a mouse. Another example of a human interface device 32 is a digital stylus. Another example of a human interface device 32 is a keyboard, A human interface device 32 may be a combination of the examples stated above.

The cells 28, 30 may be configured to be selectable. Selectable cells 28, 30 may be interactable by a clicking. If configured to be clickable, there is no need to drag and drop the cells 28, 30. The clicking functions similar to a drag and drop interaction, except the destination of the clicked cell is predetermined. In contrast, a drag and drop interaction relies on the user to select a particular destination to be dropped.

FIG. 3A shows one cell 28 having an unselected state and another cell 30 in a selected state. Preferably, each cell 28, 30 includes an unselected state, and a selected state and the user is allowed to change the state of the cell from one to another. FIG. 3A shows the user interface 26 including a first query area 34. Although FIG. 3A shows two cells 28, 30 in the first query area 34, any number of cells may be displayed in the first query area 34. FIG. 3A shows a second query area 36, including a first query tab 38. FIG. 3A shows a first query window 40 that is associated with the first query tab 38, so that the first query window 40 is displayed when the first query tab 38 is selected. The first query window 40 is configured to display the cells that are dragged and dropped into the first query window 40.

FIG. 3A also shows the user interface 26 including the first query area 34 including a first variable tab 37 and a second variable tab 39. When the first variable tab 37 is selected, the set of cells 28, 30 would be displayed in the first query area 34 as shown in FIG. 3A. When the second variable tab 39 is selected as shown in FIG. 3B, a different set of cells 62, 64 are displayed in the first query area 34. In this manner, different sets of cells may be grouped depending on the variable associations and kept organized with variable tabs 37, 39 for easier selection of the cells.

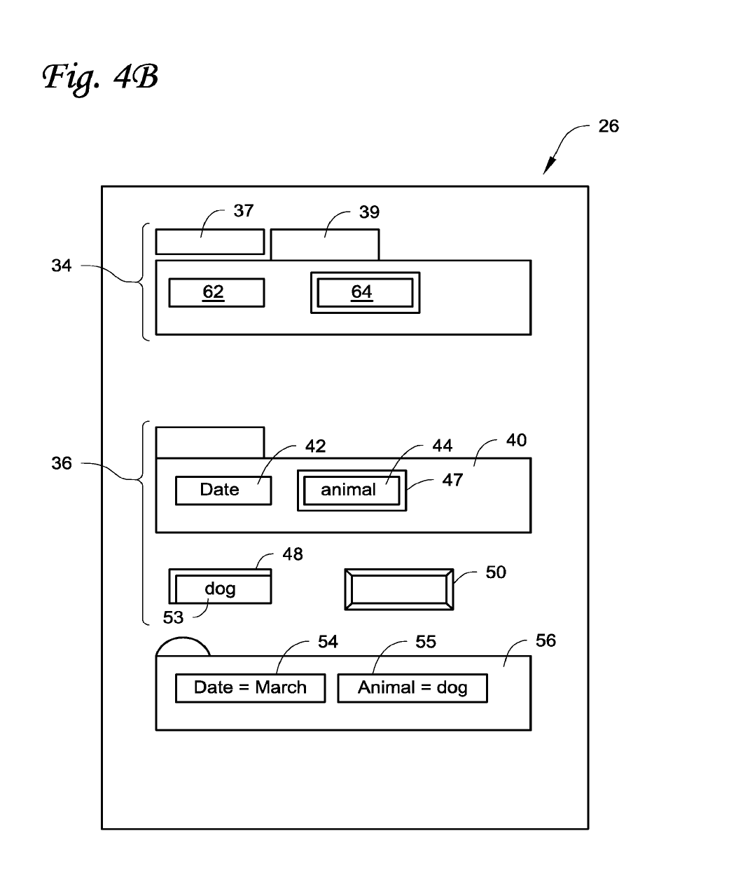

FIG. 4A shows the first query window 40 displaying cell 42 in the first query window 40. For example, cell 42 may be the selected version of cell 30. For example, cell 42 may be the dragged and dropped version of cell 30. FIG. 4A shows the cell 42 displayed in the first query window and is configured to be selectable. When the cell 42 is selected, a visual indicator 46 of the cell 42 indicates that the cell 42 is in the selected state. A visual indicator 46 includes anything that allows the user to understand that the cell has been selected for interaction with the user. For example, and not limited to, the visual indicator 46 may be a change in the color of the cell and/or a border around the selected cell. For simplicity, FIG. 4A shows the visual indicator 46 as a border around the selected cell 42.

FIG. 4A also shows the user interface 26 including the data cell 48 and the commit button 50. The data cell 48 is configured to accept a data 52 that is entered and display the data 52. An example of a data cell 48 is a text box. Another example of the data cell 48 is a plurality of text boxes. For example, the data cell 48 may include a first text box and a second text box, wherein the first text box is for entering and displaying a lowest data range limit, and the second text box is for entering and displaying a highest range limit. When the commit button 50 is activated, for example, by clicking it, the data 52 displayed in the data cell 48 becomes logically linked to the cell 42 in the first query window 40 that is in the selected state and a linked cell 54 that visually represents the selected cell 42 and the logically linked data 52 is displayed in a query display area 56.

FIG. 4B shows the second variable tab 39 having been selected. Accordingly, the cells 62, 64 are displayed in the first query area 34. FIG. 4B shows the first query window 40 displaying the cell 42 and cell 44. For example, cell 44 may be the selected version of cell 64. For example, cell 44 may be the dragged and dropped version of cell 64. FIG. 4B shows the cell 44 to be selected, with a visual indicator 47. For example, the visual indicator 47 is shown as a border around the selected cell 44. It will be understood that a visual indicator 47 may be anything that allows the user to understand that the cell has been selected for interaction with the user. The displayed cells 42, 44 in the first query window 40 are linked together by a first logic operator.

FIG. 4B shows the data cell 48 and the commit button 50. The data cell 48 accepts data 53 and displays the data 53. When the commit button 50 is activated, the data 53 becomes logically linked to the cell 44 in the first query window 40 that is in the selected state. Further, a linked cell 55 that visually represents the selected cell 44 and the logically linked data 53 is displayed in the query display area 56. The linked cells 54, 55 in the query display area 56 are linked together by the first logic operator.

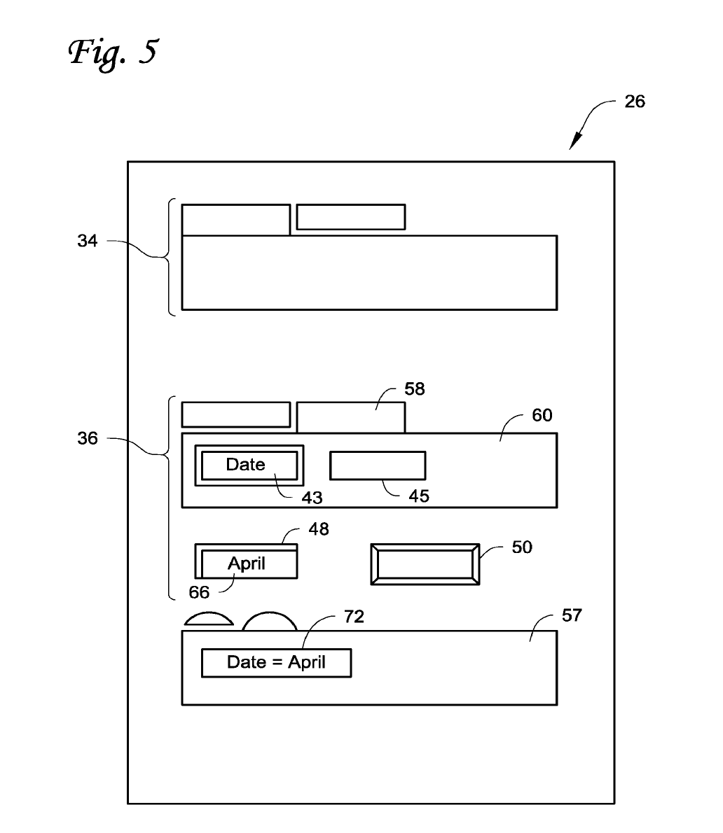

FIG. 5 shows the user interface 26 with the second query area 36 that includes a second query tab 58. FIG. 5 shows a second query window 60 associated with the second query tab 58. When the second query tab 58 is selected, the second query window is displayed 60. FIG. 5 shows the second query window 60 with cells 62, 64 that are dragged and dropped into the second query window 60. The cells 43, 45 displayed in the second query window 60 are linked together by a second logic operator. Further, the cells 43, 45 are configured to be selectable, wherein when a cell is selected, the visual indicator of the cell indicates the selected state of the cell. FIG. 5 shows a cell 43 that has been selected and thus the cell 43 is shown in the selected state. FIG. 5 shows the data cell 48 and the commit button 50. The data cell 48 accepts and displays the data 66. When the commit button 50 is activated, the data 66 becomes logically linked to the selected cell 43. Further, a second linked cell 72 is displayed in a second query display area 57. All the linked cells in the second query display area 57 are linked together by the second logic operator.

In an embodiment, the first query window 40 is a first parenthetical expression of the cells displayed in the first query window 40, the second query window 60 is a second parenthetical expression of the cells displayed in the second query window 60, and the first parenthetical expression is linked by a third logic operator to the second parenthetical expression.

In an embodiment, the query display area 56 is a first parenthetical expression of the linked cells displayed in the query display area 56, the second query display area 57 is a second parenthetical expression of the linked cells displayed in the second query display area 57, and the first parenthetical expression is linked by a third logic operator to the second parenthetical expression.

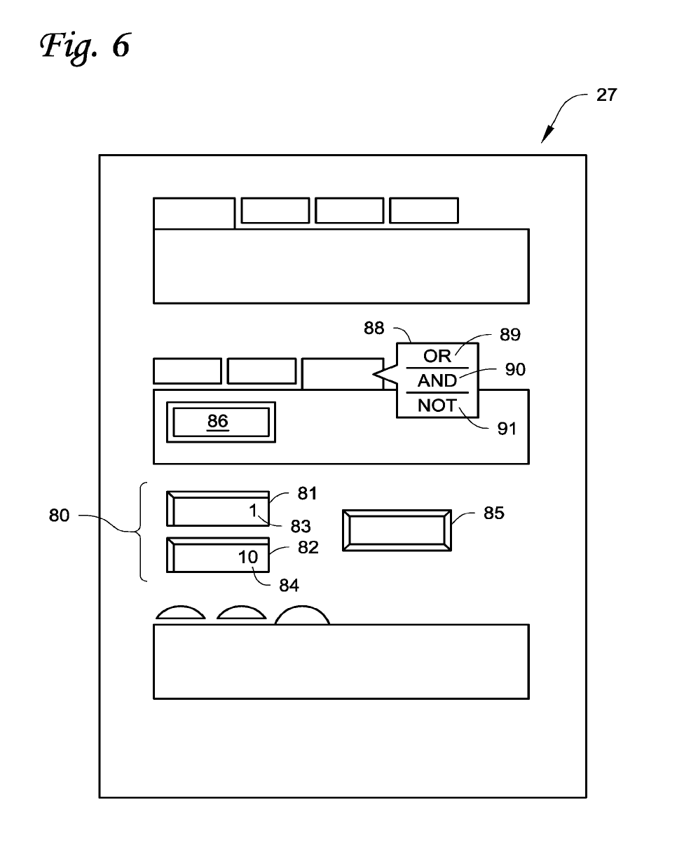

The first query tab 38, the second query tab 58, and other types of tabs stated herein, may be configured to be selectable as to the type of logical connective that it represents. For example, the first query tab 38 and the second query tab 58, each may have a menu 88 displaying a predetermined list of possible logical connectives for the user to select. For example, the menu 88 may be a list of items 89, 90, 91 that may be selected by the user. An example of the menu 88 being displayed for selection from a list of logical connectives 89, 90, 91 that sets the logic operator is shown is FIG. 6.

FIG. 6 shows a user interface 27 that is similar to those shown in FIGS. 3A-5 but having a data cell 80 that includes two text boxes 81, 82, wherein a first text box 81 is for entering a lowest limit of data 83 and a second text box 82 is for entering a highest limit of data 84. When the commit button 85 is activated, the selected cell 86 is logically linked to the range of data represented by the lowest limit of data 83 and the highest limit of data 84.

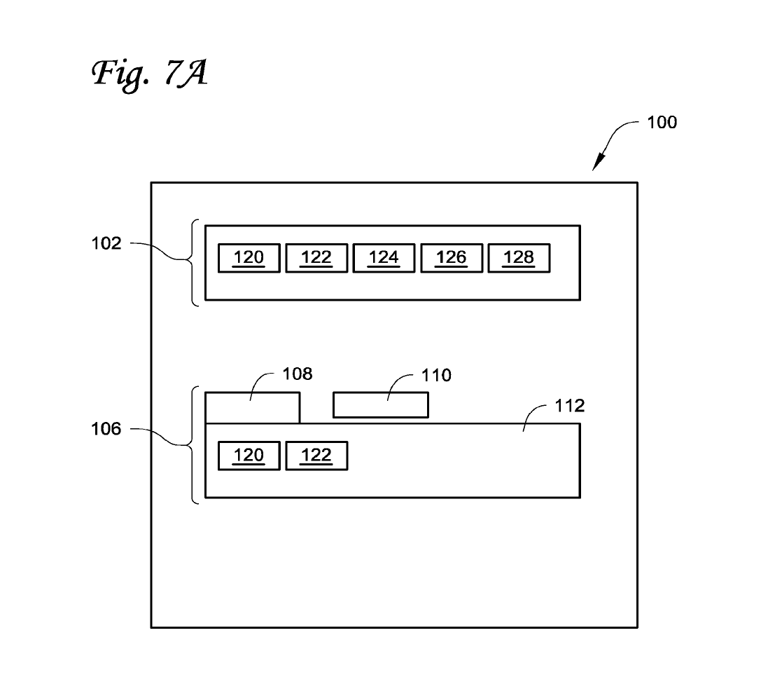

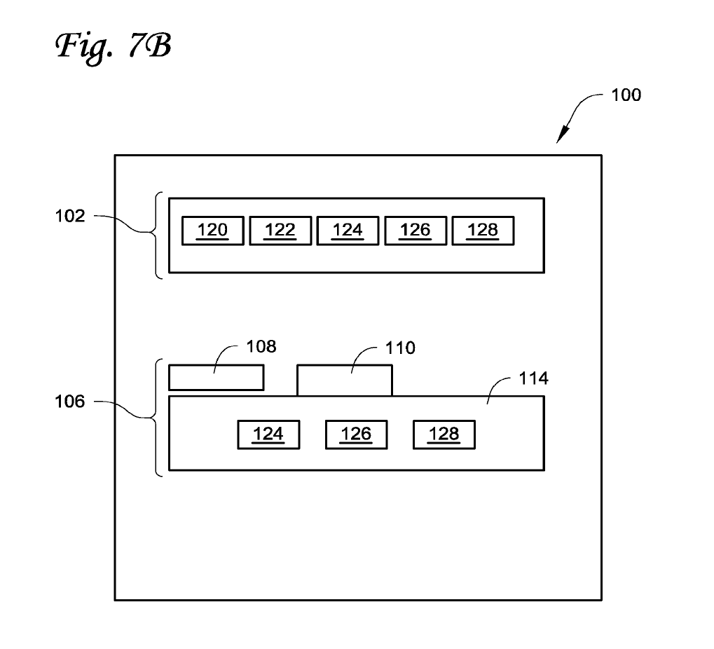

FIG. 7A shows another embodiment, wherein a user interface 100 includes a query area 102 showing a plurality of cells 120, 122, 124, 126, 128. FIG. 7A shows the user interface 100 also including a cell display area 104. FIG. 7A shows a query building area 106, including a first query tab 108, and a second query tab 110. FIG. 7A shows a first query window 112 that is associated with the first query tab 108, wherein the first query window 112 is displayed when the first query tab 108 is selected. The first query window 112 is configured to display any of the cells that are dragged and dropped into the first query window 112. FIG. 7A shows cells 120, 122 have been dragged and dropped into the first query window 112. When the cells 120, 122 are dragged and dropped into the first query window 112, the cells 120, 122 are displayed in the first query window 112, and the cells 120, 122 displayed in the first query window 112 are linked together by a first logic operator.

FIG. 7B shows the user interface 100 wherein the second query tab 110 has been selected. FIG. 7B shows a second query window 114 associated with the second query tab 110, wherein the second query window 114 is displayed because the second query tab 110 is selected. The second query window 114 is configured to display any of the cells that are dragged and dropped into the second query window 114. FIG. 7B shows that the cells 124, 126, 128 are dragged and dropped into the second query window 114, the cells 124, 126, 128 are displayed in the second query window 114, and the cells 124, 126, 128 displayed in the second query window 114 are linked together by a second logic operator.

FIGS. 7A and 7B, together show the first query window 112 that is a first parenthetical expression of the cells 120, 122 displayed in the first query window 112, the second query window 114 is a second parenthetical expression of the cells 124, 126, 128 displayed in the second query window 114; and the first parenthetical expression of the cells 120, 122 displayed in the first query window 112 is linked by a third logic operator to the second parenthetical expression of the cells 124, 126, 128 displayed in the second query window 114.

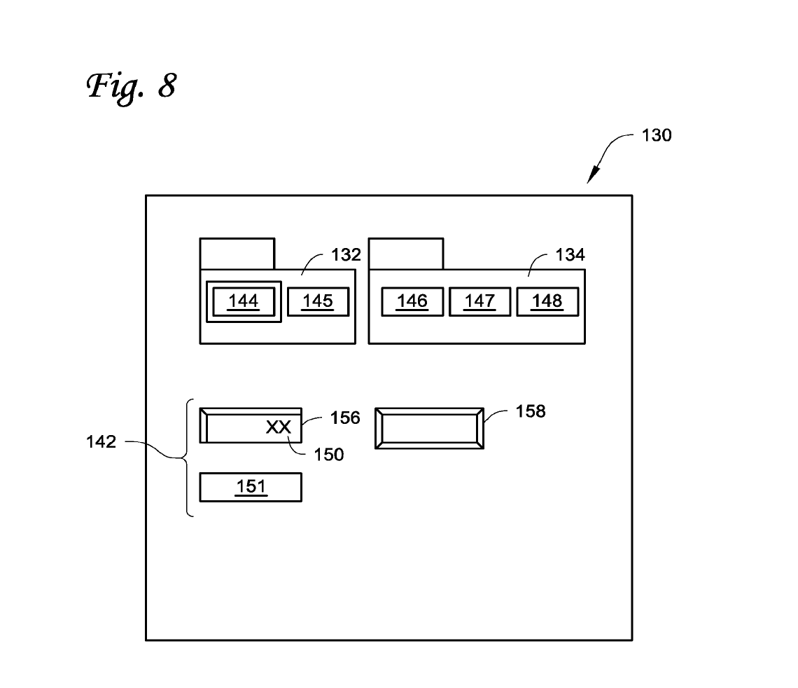

FIG. 8 shows a user interface 130 similar to that shown in FIG. 7A, wherein cells 144, 145, 146, 147, 148 displayed in the first and the second query windows 132, 134 are configured to be selectable, wherein the cell that has been selected is visually represented as a selected cell 144. The user interface 130 further includes a query display area 142. FIG. 8 shows the selected cell 144 and a query display area 142, wherein the query display area 142 displays a data cell 156, and a confirmation cell 158. The selected cell 144 is already selected and visually represents the cell that has been selected. For example, when a cell is selected, the cell may also change a visual representation thereof as an acknowledgement of the selection. The data cell 156 is configured to accept entering a data 150 and display the data 150 entered. The confirmation cell 158 is configured to be clickable, wherein when the confirmation cell 158 is clicked, the selected cell 144 is logically linked to the data 150 entered in the data cell 156. Further, when the confirmation cell 158 is clicked, a linked cell 151 is displayed in the query display area 142, wherein the linked cell 151 represents the selected cell 144 that is logically linked to the data 150. The query display area 142 is configured to logically link the linked cells that are displayed in the query display area 142. The logical links may be formed automatically, upon the linked cells being displayed in the query display area 142. When there are more than one linked cells displayed in the query display area 142, the linked cells displayed in the query display area 142 are logically linked together by a logic operator.

Multiple query display areas are also possible. When there are multiple query display areas, each query display area is a parenthetical expression of the cells displayed in the query display area and the parenthetical expressions are further logically linked with each other.

All of the tabs stated herein, may be configured to be selectable as to the type of logical connective that it represents. For example, the third query tab 136 and the fourth query tab 138, each may have a configuration of predetermined selectable menu. For example, the predetermined selectable menu may be a list of items interactable via the user.

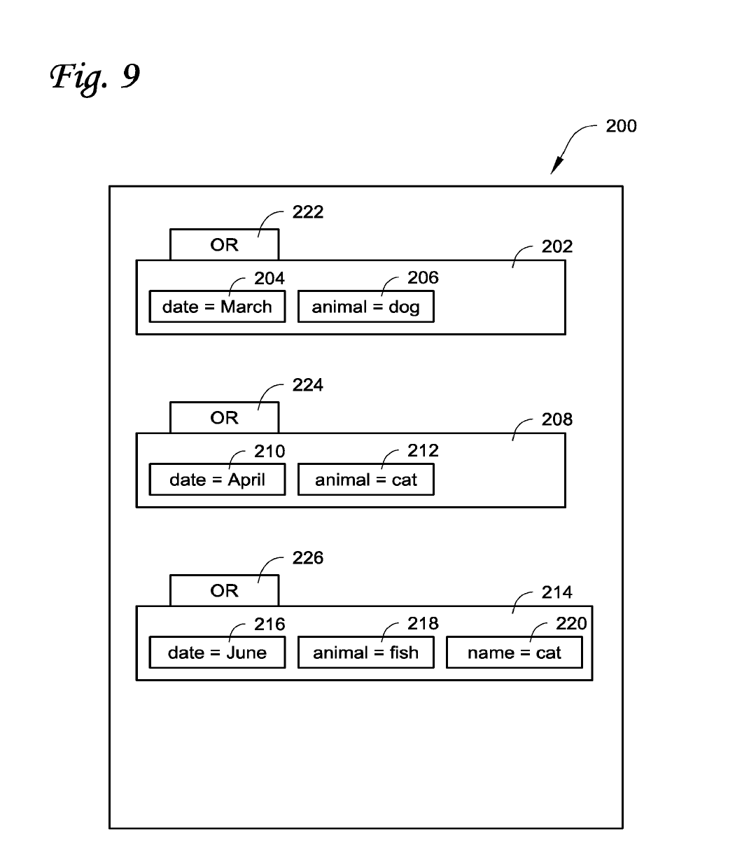

FIG. 9 shows a user interface 200 that has built a search query that would make the same request from a data base as the following text string search query.

(date=“March” AND animal=“dog”) OR (date=“April” AND animal=“cat”)

OR (date=“June” AND animal=“fish” AND name=“cat”)

Wherein, a first query display area 202 includes cell 204 titled “date” with data “March” linked to it, logically linked with an AND operator to cell 206 titled “animal” with data “dog” linked to it. The second query display area 208 includes cell 210 titled “date” with data “April” linked to it, logically linked with an AND operator to cell 212 titled “animal” with data “cat” linked to it. The third query display area 214 includes cell 216 titled “date” with data “June” linked to it, logically linked with an AND operator to cell 218 titled “animal” with data “fish” linked to it, logically linked with an AND operator to cell 220 titled “name” with data “cat” linked to it. The first, second, and third query display areas 202, 208, 214 are logically linked with OR operators, shown in the respective tabs 222, 224, 226 associated with each of the query windows. The user interface 200 shown in FIG. 9 is easier to use and understand than using a text string search query shown above.

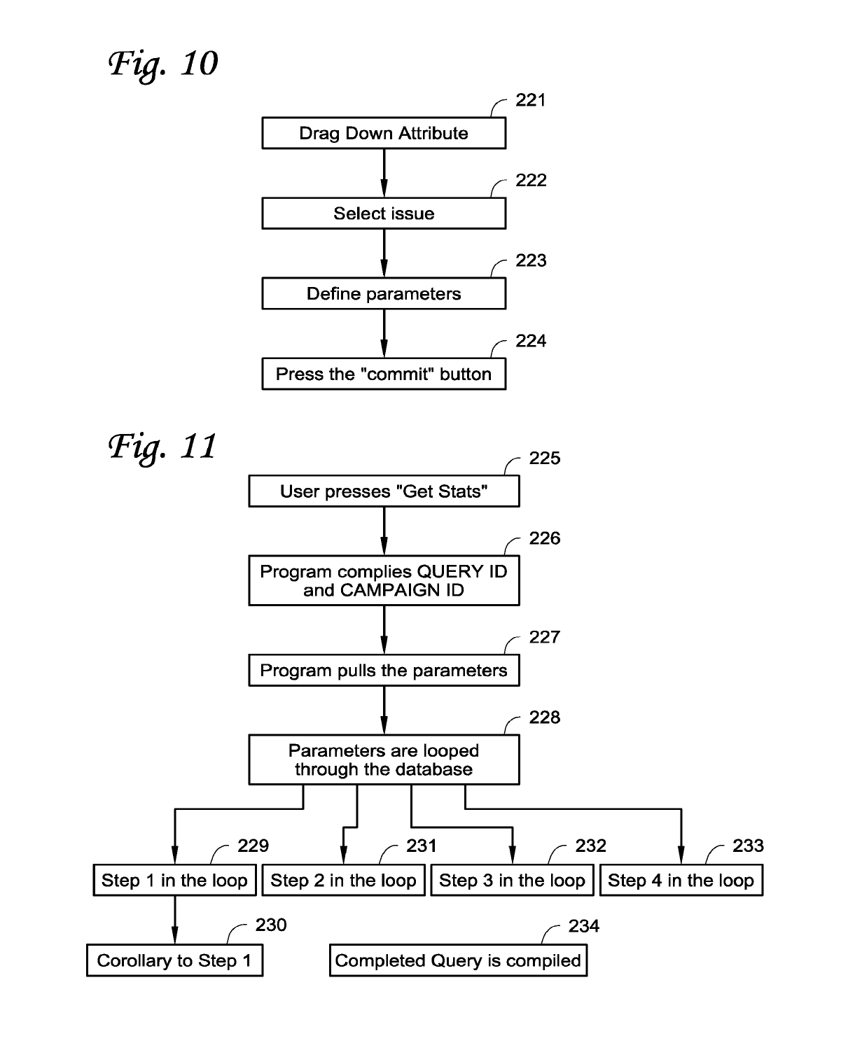

FIG. 10 shows an embodiment of a user interface that has four main steps. FIG. 10 shows four main steps 221, 222, 223, 224 from the user's point of view when using an embodiment of the user interface. In the first step of the embodiment, the user selects an attribute 221. In an embodiment, selecting an attribute 221 is via a drag & down menu selection. When an attribute is selected 221, a processor receiving the attribute selection from the user interface concurrently seeks out the amount of people in the database who have the selected attribute from the selection step 221. Next, the user selects an issue 222 to associate with the selected attribute. The selected attribute may be one or more than one. The processor then assigns a unique identifier to meld the user-selected issue 222 with the query attribute 221 and a parameter. In an embodiment, the unique identifier is a randomly generated QUERY ID. In an embodiment, the QUERY ID is stored in an Operational Data Store of a memory storage device.

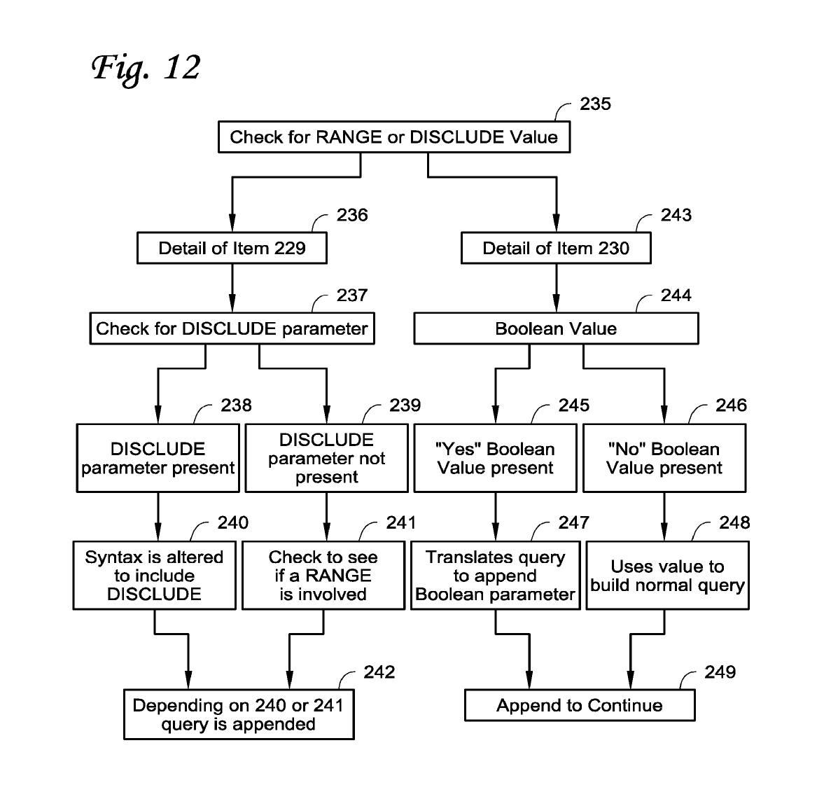

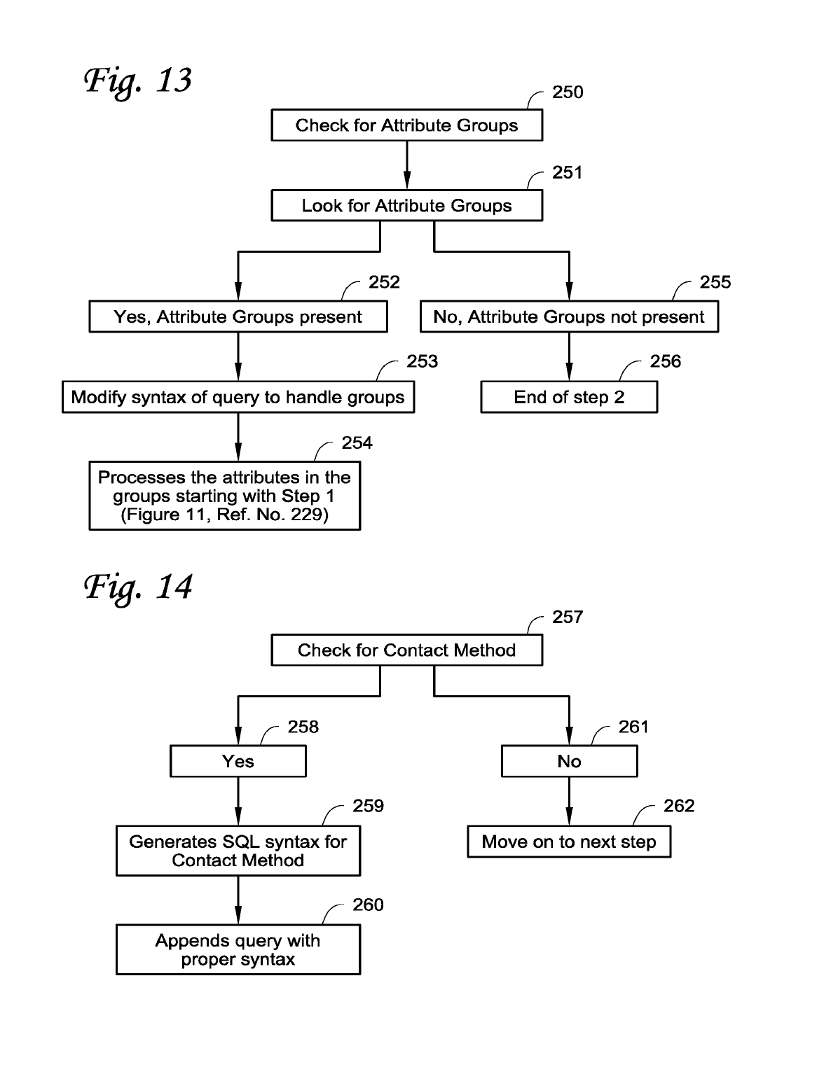

FIG. 11 shows an embodiment of a user interface. In step 225 the user presses a button in a user interface that initiates the processor from accessing a database stored in memory in order to process a count of individuals in the database that has the parameters of the query created. For example, the button on a user interface may be labeled “Get Stats.” Wherein, the user pressing the button labeled “Get Stats” initiates the processor from performing an algorithm for accessing a database stored in a memory, for processing and/or quantifying a number of individuals and/or identities that match and/or has the parameters the query created. In step 226, the processor performs an algorithm and/or a program that compiles the unique identifies, for example, QUERY ID. The processor may also compile the campaign identification along with the unique identifiers. For example, a CAMPAIGN ID may be designated to identify the campaign for which the user is using the user interface. As a further example, in the step 226, the processor may perform an algorithm and/or a program that compiles the unique identifies, for example, QUERY ID and the campaign identification, for example, a CAMPAIGN ID. In step 227, the processor performs an algorithm and/or a program that references the QUERY ID and the CAMPAIGN ID, gathers the relevant data, such as attributes and/or parameters. In step 228, the processor performs an algorithm and/or a program that loops through the database in search of the relevant attributes and/or parameters for creating a compiled set of data and/or list of data.

FIG. 11 also shows four steps 229, 231, 232, 233, that represent steps in a loop algorithm. The loop algorithm is performed by the processor after step 228 and/or as a part of step 228 and/or with step 228. For simplification, the four steps 229, 231, 232, 233 are denoted as Step 1 in the loop, Step 2 in the loop, Step 3 in the loop, Step 4 in the loop, respectively in FIG. 11. It will be understood that the loop algorithm may include other steps than the four steps 229, 231, 232, 233. It will be understood that the loop algorithm may include any number of the four steps 229, 231, 232, 233, in any sequence, in any order. Accordingly, the loop algorithm may include only one of the four steps 229, 231, 232, 233.

It will be understood that no matter how many steps there are in the loop algorithm, the processor may make a determination as to which one or more of the steps 229, 231, 232, 233 in the loop algorithm is to be performed. Accordingly, for example, the processor may perform only one of the four steps 229, 231, 232, 233. Further, for example, the processor may perform only few of the four steps 229, 231, 232, 233, in any sequence as determined by the processor according to another algorithm making such determination.

Further, it will be understood that the Step numbers shown in FIG. 11 do not necessarily represent the particular sequence of steps in the loop. Accordingly, it will be understood that other steps may be included between the Step numbers. For example, there may be a step between Step 1 and Step 2, and likewise with other Steps in the loop shown in FIG. 11.

In Step 1 in the loop 229 shown in FIG. 11, a processor uses an algorithm for analysis of an attribute and checks for and/or determines whether the attribute is and/or includes a RANGED parameter. An example of the RANGED parameter is AGE=20 to 30. The processor may check for more than one value in the attribute parameter in the step 229. If the parameter is determined by the processor to have a RANGE parameter and/or DISCLUDE parameter, then the query is modified to include the RANGE and/or DISCLUDE command.

Step 1 in the loop 229 may include a corollary process and/or step 230 wherein if the parameter is determined by the processor to not have a RANGE parameter and/or does not have a DISCLUDE parameter, then the processor determines that the step 229 is completed and/or skips to the next step in the loop algorithm and/or ends the loop algorithm and/or continues to the Completed Query 234 shown in FIG. 11.

In Step 2 in the loop 231 shown in FIG. 11, a processor uses an algorithm for checking for and/or determining for multiple groups of queries. As shown in FIG. 5, query tab 58, the user interface provides one and/or plurality of tabs to create one and/or multiple sub-sets of queries to make at least one complete query.

In Step 3 in the loop 232 shown in FIG. 11, a processor uses an algorithm for checking and/or determining if the query is looking to sort by contact method, wherein contact method includes a mail contact and/or an e-mail contact and/or telephone contact and/or texting contact and/or social network contact and/or a combination thereof. If the query was not selected for this in the user selected attributes, and the parameters then this Step may be skipped and/or ignored by the processor.

In Step 4 in the loop 233 shown in FIG. 11, a processor uses an algorithm for checking and/or determining the user selected parameters for sorting by one or more response(s) to one or more survey question(s) in the database. For example, a survey question may be “Will you vote for Candidate X?” If the query was not selected for this in the user selected attributes, and the parameters then this Step may be skipped and/or ignored by the processor.

In step 234 shown in FIG. 11, a processor determines whether all of the selected attributes and/or parameters have been processed via the loop algorithm and finalizes the results and compiled and stored onto a memory. Compiling and storing the results may be as a list form and/or database.

FIG. 12 shows an embodiment of combined Step 1 in the loop 229 and corollary step 230. In the embodiment of the query building process, the first step in the loop is to check and see if there is more than one value in the attributes parameter. This may be determined by, for example, for checking to see if text box 82 of a user interface has a highest limit of data 84 as shown in FIG. 6 and described above in regards to FIG. 6. If the processor concludes that there is more than one value in the attributes parameter, as shown in step 236, the processor then performs the next step in the algorithm to check for whether there is a DISCLUDE parameter as referenced in step 237. In step 237, the processor checks for and/or determines whether DISCLUDE parameter is set by the user using the user interface. If there is a DISCLUDE parameter present 238, then the syntax of the query is altered 240 to reflect this parameter and the loop algorithm continues as shown in step 242. If there is not a DISCLUDE parameter present 239, but more than one value is present, then the processor determines that a RANGE parameter is involved in the query 241. The syntax of the query is altered 241 to reflect this parameter and the loop algorithm continues as shown in step 242.

In step 243, more than one value is present but not a RANGE parameter nor a DISCLUDE parameter. As shown in FIG. 12, the processor checks in step 244 for a Boolean value, and depending on whether the Boolean value is present 245 or not present 246, the processor proceeds to either translating the query to append the Boolean parameter in step 247 following step 245, or in using the value to build a normal query 248 following step 246.

From either step 247 and/or step 248, step 249 follows, wherein the processor finishes off the process and the attribute is finalized and the program loops to the next step.

FIG. 13 shows an embodiment of Step 2 in the loop 231 shown in FIG. 11. In step 250, a processor checks for attributes in different grouping tabs of the user interface. For example, such a grouping is shown as menu 88 in FIG. 6. In step 251, the processor looks for attribute groups. When the grouping tabs have user selected attributes and parameters present 252, then syntax of query to handle groups is modified 253. Then the processor processes the attributes. For example, the processor processes the attributes in the groups starting with that in Step 1 in the loop 229. If looking for the attribute groups 251 results in no attribute groups being present 255, then the Step 2 in the loop 231 ends 256 and moves to Step 3 in the loop 232.

FIG. 14 shows an embodiment of Step 3 in the loop 232 shown in FIG. 11. The embodiment includes a step wherein a processor checks to see if a query is searching for a Contact Method 257. An example of a query searching for a Contact Method is finding all voters who were contacted by a Contact Method. Examples of Contact Method are mail, email, text messaging, social network, and/or telephone. If there is a Contact Method attribute request 258 then the proper SQL syntax is created 259. Then the query is appended with the proper query syntax 260. If there is not a Contact Method attribute request 261, then the Step 3 in the loop 232 ends 262 and moves to Step 4 in the loop 233.

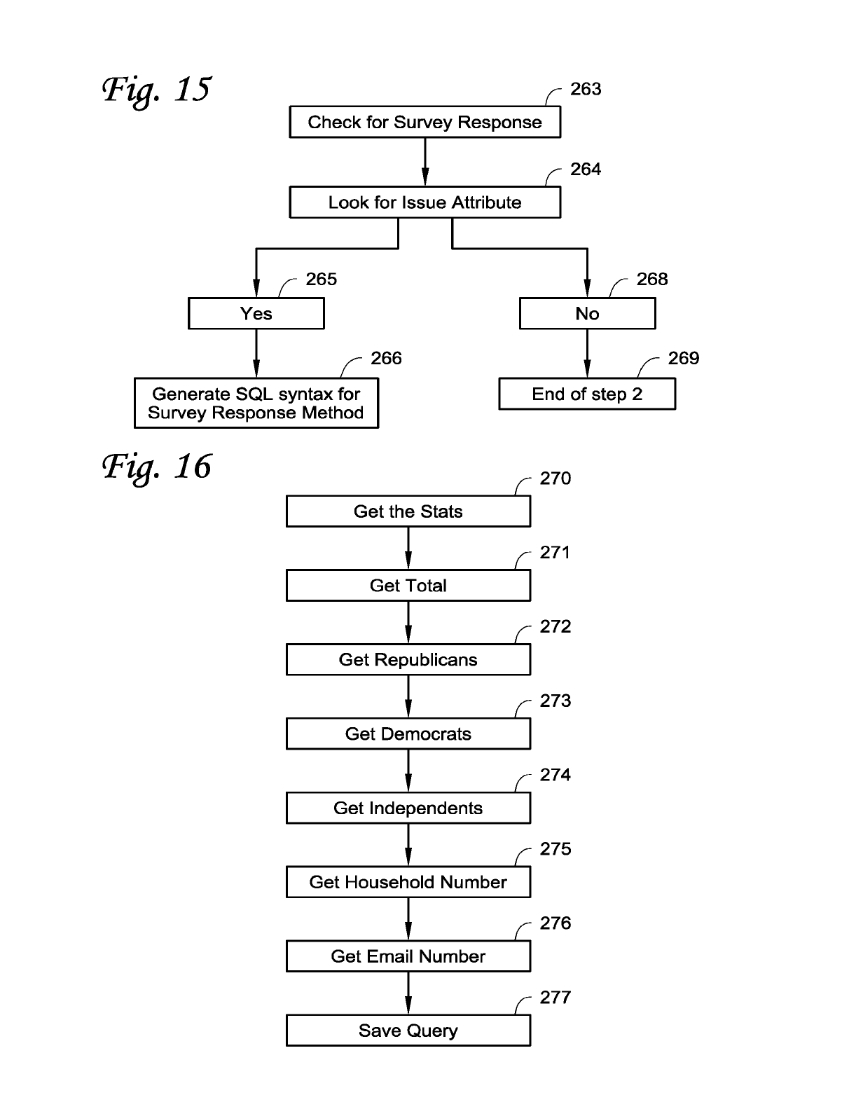

FIG. 15 shows an embodiment of Step 4 in the loop 233 shown in FIG. 11. The embodiment includes a step wherein a processor checks for a Survey Response 263. In checking for a Survey Response 263, the processor checks if one of the attributes calls for a response to a survey and if so which issue attribute the survey response was referencing 264. For example, an issue may be “healthcare.” For example, an issue may be “taxes.” An issue many be any subject matter which may influence a person to vote in a particular way and/or vote for a particular candidate. If there is an issue attribute 265 then the proper syntax is formed and appended to the query 266. If there is not an issue attribute 268, then the Step 4 in the loop 233 ends 269.

Generally, steps that may follow the process shown in FIG. 11 may be an automated processing of retrieved data and/or grouping a total number of data retrieved by a query into sub-groupings, each sub-grouping having a sub-total number of data retrieved by the query.

FIG. 16 shows an embodiment of steps that may follow the process shown in FIG. 11. The steps shown in FIG. 16 is not necessarily limited by the sequence shown therein. The sequence of steps is for example purpose. Alternate sequences are envisioned. Parallelization of the one or more steps shown in FIG. 16 is also envisioned.

As shown in FIG. 16, for example, when a user using the user interface desires to have a compiled analytics and/or an output, the user may interact with the user interface according to the embodiment shown in FIG. 16. In step 270 of the embodiment, the user has finished building the query using the user interface and query has been compiled resulting in totaling of the statistics from the database. In the embodiment, initializing the compiling process is done by interacting with a button in the user interface, which results in the processor processing the compilation of the query. In step 271 of the embodiment, the processor accesses the database and retrieves a total number of individuals and the associated data in the database who fit the parameters of the query. In step 272 of the embodiment, that total number of individuals and the processor retrieves a sub-total of the number of Republicans. In step 273 of the embodiment, that total number of individuals and the processor retrieves a sub-total of the number of Democrats. In step 274 of the embodiment, that total number of individuals and the processor retrieves a sub-total of the number of Independents. In step 275 of the embodiment, that total number of individuals and the processor retrieves a sub-total of Households. In step 276 of the embodiment, that total number of individuals and the processor retrieves a sub-total of individuals with e-mail addresses. In step 277, the totals and sub-totals retrieved by the processor is saved onto a medium. In step 277, the totals and sub-totals may be displayed on the display screen.

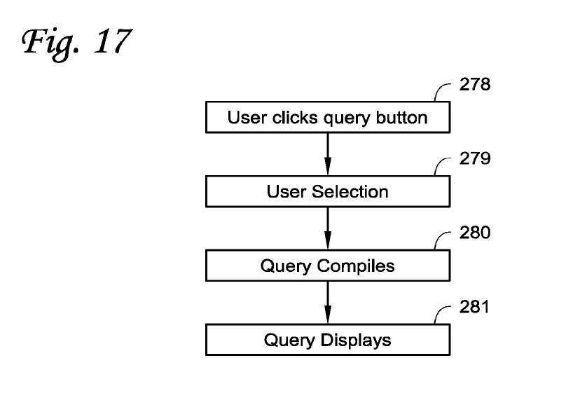

In FIG. 17 shows an embodiment of steps following compilation of stats for creating an output of the query results. For example, the output of the query results may be in a list format. In step 278, a user initiates the output generation by interacting with the user interface. An example of such interaction may be a clicking of a button of the user interface. In step 279, the user selects the desired format of the output. Desire format is the form the resulting data will be outputted. The format may be electronic. The format may be a printout on paper. In step 280, the processor compiles the output into the desired format. In step 281, the output is generated to the desired format.

Preferred embodiments have been described. Those skilled in the art will appreciate that various modifications and substitutions are possible, without departing from the scope of the invention as claimed and disclosed, including the full scope of equivalents thereof.

What is claimed is:

1. A computer, comprising:
a user interface displayed on a display device, including:
a plurality of cells that are interactable;
each cell including an unselected state, and a selected state,
a first query area, including at least one cell;
a second query area, including:
a first query tab;
a first query window associated with the first query tab,
wherein the first query window is displayed when the first query tab is selected,
wherein the first query window is configured to display the cells that are dragged and dropped into the first query window, and
wherein the cells displayed in the first query window are linked together by a first logic operator;
the cell that is dragged and dropped is configured to be selectable, wherein when the cell is selected, a visual indicator of the cell indicates the selected state of the cell;
a data cell;
a commit button;
wherein the data cell is configured to accept entering a data, and display the data entered,
wherein when the commit button is activated, the data is logically linked to the cell that is in the selected state, and a linked cell is displayed in a query display area, wherein the linked cell visually represents the cell that is in the selected state and logically linked to the data.

2. The computer according to claim 1, wherein the second query area further incluctes:
a second query tab;
a second query window associated with the second query tab,
wherein the second query window is displayed when the second query tab is selected,
wherein the second query window is configured to display the cells that are dragged and dropped into the second query window, and
wherein the cells displayed in the second query window are linked together by a second logic operator,
the cell that is dragged and dropped is configured to be selectable, wherein when the cell is selected, the visual indicator of the cell indicates the selected state of the cell;
a second data cell;
a second commit button;
wherein the second data cell is configured to accept entering a second data, and display the second data entered,
wherein the second commit button is clickable,
wherein when the second commit button is activated, the second data is logically linked to the cell that is in the selected state displayed in the second query window, and a second linked cell representing the cell in the selected state displayed in the second query window that is logically linked to the second data is displayed in the query display area;
the first query window is a first parenthetical expression of the cells displayed in the first query window;
the second query window is a second parenthetical expression of the cells displayed in the second query window; and
the first parenthetical expression is linked by a third logic operator to the second parenthetical expression.

3. A computer, comprising:
a display device; and
a user interface displayed on the display device, including:
a query area, including:
a plurality of cells;
each cell configured to be interacted via drag and drop;
a cell display area displayed on the display device that displays the cells;
a query building area, including a first query tab, and a second query tab;
a first query window associated with the first query tab,
wherein the first query window is displayed when the first query tab is selected,
wherein the first query window is configured to display the cells that are dragged and dropped into the first query window, and
wherein the cells displayed in the first query window are linked together by a first logic operator;
a second query window associated with the second query tab,
wherein the second query window is displayed when the second query tab is selected,
wherein the second query window is configured to display the cells that are dragged and dropped into the second query window, and
wherein the cells displayed in the second query window are linked together by a second logic operator;
the first query window is a first parenthetical expression of the cells displayed in the first query window;
the second query window is a second parenthetical expression of the cells displayed in the second query window; and
the first parenthetical expression of the cells displayed in the first query window is linked by a third logic operator to the second parenthetical expression of the cells displayed in the second query window.

4. The computer according to claim 3, wherein the cells displayed in the first and the second query windows are configured to be selectable, wherein the cell that has been selected is visually represented as a selected cell,
the user interface further comprising:
a query display area;
a cell display area that displays a data cell, and a confirmation cell,
wherein the data cell is configured to accept entering a data and display the data entered,
wherein the confirmation cell is configured to be clickable,
wherein when the confirmation cell is clicked,
the selected cell is logically linked to the data entered in the data cell, and a linked cell is displayed in the query display area,
wherein the linked cell represents the selected cell that is logically linked to the data;
the query display area configured to logically link the linked cell.

5. The computer according to claim 4, wherein the user interface further comprises:
a second query display area configured to display one or more linked cells;
the query display area is a third parenthetical expression of the linked cells displayed in the first query display area;
the second query display area is a fourth parenthetical expression of the linked cells displayed in the second query display area; and
the third parenthetical expression is linked by a fourth logic operator to the fourth parenthetical expression.

6. The computer according to claim 4,
wherein the data cell includes a first text box and a second text box,
wherein the first text box is configured to accept and display a lowest range limit of data,
wherein the second text box is configured to accept and display a highest range limit of data, and
wherein when the selected cell is logically linked to the data entered in the data cell, the selected cell is logically linked to a range of data defined by the lowest range limit of data and the highest range limit of data.

7. A user interface displayed on a display device of a computer, comprising:
a plurality of cells that are interactable via drag and drop;
each cell including an unselected state, and a selected state,
a first query area, including at least one cell;
a second query area, including:
a first query tab;
a first query window associated with the first query tab,
wherein the first query window is displayed when the first query tab is selected,
wherein the first query window is configured to display the cells that are dragged and dropped into the first query window, and
wherein the cells displayed in the first query window are linked together by a first logic operator;
the cell that is dragged and dropped is configured to be selectable, wherein when the cell is selected, a visual indicator of the cell indicates the selected state of the cell;
a data cell;
a commit button;
wherein the data cell is configured to accept entering a data, and display the data entered,
wherein when the commit button is activated, the data is logically linked to the cell that is in the selected state, and a linked cell is displayed in a query display area, wherein the linked cell visually represents the cell that is in the selected state and logically linked to the data.

8. The user interface according to claim 7, wherein the second query area further includes:
a second query tab;
a second query window associated with the second query tab,
wherein the second query window is displayed when the second query tab is selected,
wherein the second query window is configured to display the cells that are dragged and dropped into the second query window, and
wherein the cells displayed in the second query window are linked together by a second logic operator,
the cell that is dragged and dropped is configured to be selectable, wherein when the cell is selected, the visual indicator of the cell indicates the selected state of the cell;
a second data cell;
a second commit button;
wherein the second data cell is configured to accept entering a second data, and display the second data entered,
wherein the second commit button is clickable,
wherein when the second commit button is activated, the second data is logically linked to the cell that is in the selected state displayed in the second query window, and a second linked cell representing the cell in the selected state displayed in the second query window that is logically linked to the second data is displayed in the query display area;
the first query window is a first parenthetical expression of the cells displayed in the first query window;
the second query window is a second parenthetical expression of the cells displayed in the second query window; and
the first parenthetical expression is linked by a third logic operator to the second parenthetical expression.

9. A user interface displayed on a display device of a computer, comprising:
a query area, including:
a plurality of cells;
each cell configured to be interacted via drag and drop;
a cell display area displayed on the display device that displays the cells;
a query building area, including a first query tab, and a second query tab;
a first query window associated with the first query tab,
wherein the first query window is displayed when the first query tab is selected,
wherein the first query window is configured to display the cells that are dragged and dropped into the first query window, and
wherein the cells displayed in the first query window are linked together by a first logic operator;
a second query window associated with the second query tab,
wherein the second query window is displayed when the second query tab is selected,
wherein the second query window is configured to display the cells that are dragged and dropped into the second query window, and
wherein the cells displayed in the second query window are linked together by a second logic operator;
the first query window is a first parenthetical expression of the cells displayed in the first query window;
the second query window is a second parenthetical expression of the cells displayed in the second query window; and
the first parenthetical expression of the cells displayed in the first query window is linked by a third logic operator to the second parenthetical expression of the cells displayed in the second query window.

10. The user interface according to claim 9, wherein the cells displayed in the first and the second query windows are configured to be selectable, wherein the cell that has been selected is visually represented as a selected cell,
the user interface further comprising:
a query display area;
a cell display area that displays a data cell, and a confirmation cell,
wherein the data cell is configured to accept entering a data and display the data entered,
wherein the confirmation cell is configured to be clickable,
wherein when the confirmation cell is clicked,
the selected cell is logically linked to the data entered in the data cell, and a linked cell is displayed in the query display area,
wherein the linked cell represents the selected cell that is logically linked to the data;
the query display area configured to logically link the linked cell.

11. The user interface according to claim 10, wherein the user interface further comprises:
a second query display area configured to display one or more linked cells;
the query display area is a third parenthetical expression of the linked cells displayed in the first query display area;
the second query display area is a fourth parenthetical expression of the linked cells displayed in the second query display area; and
the third parenthetical expression is linked by a fourth logic operator to the fourth parenthetical expression.

12. The user interface according to claim 10,
wherein the data cell includes a first text box and a second text box,
wherein the first text box is configured to accept and display a lowest range limit of data,
wherein the second text box is configured to accept and display a highest range limit of data, and
wherein when the selected cell is logically linked to the data entered in the data cell, the selected cell is logically linked to a range of data defined by the lowest range limit of data and the highest range limit of data.

13. A method, comprising:
providing a user interface for graphically building a search query, via a network to a remote display device from a server,
wherein the user interface displayed on a display device, includes:
a plurality of cells that are interactable via drag and drop,
each cell including an unselected state, and a selected state,
a first query area, including at least one cell,
a second query area, including:
a first query tab,
a first query window associated with the first query tab,
wherein the first query window is displayed when the first query tab is selected,
wherein the first query window is configured to display the cells that are dragged and dropped into the first query window, and wherein the cells displayed in the first query window are linked together by a first logic operator,
the cell that is dragged and dropped is configured to be selectable, wherein when the cell is selected, a visual indicator of the cell indicates the selected state of the cell,
a data cell, configured to accept entering a data, and
a commit button;
displaying the data when the data is entered;
logically linking the data to the cell that is in the selected state when the commit button is activated; and
displaying the data is logically linked to and a linked cell in a query display area, wherein the linked cell visually represents the cell that is in the selected state and logically linked to the data.

14. The method according to claim 13, further comprising:
providing the second query area that further includes:
a second query tab,
a second query window associated with the second query tab,
wherein the second query window is displayed when the second query tab is selected,
wherein the second query window is configured to display the cells that are dragged and dropped into the second query window, and
wherein the cells displayed in the second query window are linked together by a second logic operator,
the cell that is dragged and dropped is configured to be selectable, wherein when the cell is selected, the visual indicator of the cell indicates the selected state of the cell,
a second data cell configured to accept entering the data, and
a second commit button that is clickable;
displaying the data entered;
logically linking the data to the cell that is in the selected state when the second commit button is clicked;
displaying a second linked cell representing the cell in the selected state that is logically linked to the data in the query display area;
logically linking the cells displayed in the first query window as a first parenthetical expression;
logically linking the cells displayed in the second query window as a second parenthetical expression; and
logically linking the first parenthetical expression by a third logic operator to the second parenthetical expression.
